(19) United States
(12) Patent Application Publication
(10) Pub. No.: US 2011/0126662 A1
(43) Pub. Date: Jun. 2, 2011

(54) PARKING BRAKE SYSTEM OF VEHICLE

(75) Inventors: Youngkyun SON, Yongin-si (KR); Wonjun HWANG, Hwaseong-si (KR)

(73) Assignees: Hyundai Motor Company, Seoul (KR); Kia Motors Corporation, Seoul (KR)

(21) Appl. No.: 12/819,027

(22) Filed: Jun. 18, 2010

(30) Foreign Application Priority Data
Dec. 1, 2009 (KR) 10-2009-0117955

(51) Int. Cl. B60T 7/08; F16D 65/30; B60T 7/00; F16C 1/10

(52) U.S. Cl. 74/502.2

(57) ABSTRACT

A parking brake system may include a lever mounting bracket including a vertical portion, an operating lever including a vertical fixing portion and a bending-fixing portion, wherein the vertical fixing portion is rotatably coupled to the vertical portion by an end portion of a lever hinge, and the bending-fixing portion is disposed from the vertical portion with a predetermined distance and rotatably coupled to the vertical portion by the other end of the lever hinge, a rotary shaft disposed with a predetermined distance from the lever hinge and having one end connected to the bending-fixing portion, a cable rod having one end connected to a portion of the rotary shaft at a predetermined distance from the vertical portion of the lever mounting bracket, and an equalizer connected to the other end of the cable rod by an adjust nut.

### CROSS-REFERENCE TO RELATED APPLICATIONS

The present application claims priority to Korean Patent Application Number 10-2009-0117955 filed Dec. 1, 2009, the entire contents of which application is incorporated herein for all purposes by this reference.

### BACKGROUND OF THE INVENTION

1. Field of the Invention

The present invention relates to a parking brake system of a vehicle which makes it possible to reduce weight and manufacturing cost by decreasing the number of parts.

2. Description of Related Art

In general, parking brake systems of vehicles, as shown in FIG. 1, include a lever mounting bracket 1 fixed to the floor panel at a side of the driver's seat, an operating lever 2 rotatably hinged to lever mounting bracket 1, a rotary shaft bracket 3 fixed to the floor panel and facing lever mounting bracket 1, a rotary shaft 4 with an end connected to operating lever 2 and the other end rotatably connected to rotary shaft bracket 3 to rotate with operating lever 2 rotating, a rotary arm 5 integrally combined with rotary shaft 4, a cable rod 6 with one end connected to rotary arm 5, and an equalizer 8 connected to the other end of cable rod 6 by an adjust nut 7.

An end of a cable connected to the rear wheels is connected to both ends of equalizer 8.

Operating lever 2 is positioned at the left and rotary shaft bracket 3 is positioned at the right in vehicles with the driver's seat at the left, as shown in FIG. 1, whereas the positions of operating lever 2 and rotary shaft bracket 3 are exchanged in vehicles with the driver's seat at the right.

Equalizer 8 should be positioned at the center of the console box in the left-right direction of the car body irrespective of the position of the driver's seat in order to reduce the left-right width of the console box, and accordingly, a wide space is secured for the passengers in the back seat. In order to achieve this configuration, parking brake systems in the related art use rotary shaft 4 protruding through one side of operating lever 2, rotary arm 5 combined with rotary shaft 4, and a rotary shaft bracket 3 rotatably supporting rotary shaft 4.

The configuration using rotary shaft bracket 3 and rotary arm 5 to install equalizer 8, however, increases the number of parts, such that the weight increases and the manufacturing cost correspondingly increases.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a parking brake system of a vehicle that makes it possible to reduce weight and manufacturing cost by decreasing the number of part, maintaining the configuration in which an equalizer is positioned at the center of the console box in the left-right direction of the car body, regardless of the position of the driver's seat.

The parking brake system may include a lever mounting bracket including a vertical portion and fixed to a floor panel at a side of a driver's seat, an operating lever including a vertical fixing portion and a bending-fixing portion, wherein the vertical fixing portion is rotatably coupled to the vertical portion of the lever mounting bracket by an end portion of a lever hinge, and the bending-fixing portion is disposed from the vertical portion of the lever mounting bracket with a predetermined distance and rotatably coupled to the vertical portion of the lever mounting by the other end of the lever hinge, a rotary shaft disposed with a predetermined distance from the lever hinge in a radial direction and having one end connected to the bending-fixing portion to rotate with the operating lever with respect to the lever hinge, a cable rod having one end connected to a portion of the rotary shaft at a predetermined distance from the vertical portion of the lever mounting bracket, and an equalizer connected to the other end of the cable rod by an adjust nut.

The vertical fixing portion and the bending-fixing portion may form an inverse U shape and receives the vertical portion of the lever mounting bracket therein.

The other end of the rotary shaft may pass through a shaft slot of the lever mounting bracket and is fixed to the vertical fixing portion of the operating lever such that the vertical fixing portion and the bending-fixing portion of the operating lever are rotated with respect to the lever hinge together, wherein the shaft slot has an arc slot shape having a predetermined curvature radius with respect to the lever hinge.

A shaft protruder radially extending from the rotary shaft may be integrally formed in the portion of the rotary shaft at a predetermined distance from the vertical portion of the lever mounting bracket and the one end of the cable rod is fitted on the portion of the rotary shaft between the shaft protruder and the bending fixing portion of the operating lever.

The lever hinge may include a bracket support spool integrally formed onto an outer circumference thereof and the vertical portion of the lever mounting bracket is rotatably coupled thereto.

The vertical fixing portion and the bending fixing portion of the operating lever may include a clamping portion at respective upper portion thereof respectively and an upper portion of the vertical portion in the lever mounting bracket is rotatably engaged between the clamping portions of the vertical fixing portion and the bending fixing portion.

According to an exemplary embodiment of the present invention, it is possible to position an equalizer at the center of the console box in the left-right direction of the car body, regardless of the position of the driver's seat. Accordingly, it is possible to reduce weight and manufacturing cost by decreasing the number of parts, as well as to ensure a wide space for the passengers in the back seat.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view illustrating a parking brake system in the related art.

FIG. 2 is a cross-sectional view taken along line I-I of FIG. 1.

FIG. 3 is a perspective view illustrating an exemplary parking brake system according to the present invention.

FIG. 4 is a cross-sectional view taken along line II-II of FIG. 3.

FIG. 5 is a view illustrating a shaft slot formed in a lever mounting bracket.

It should be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the present invention(s) will be described in conjunction with exemplary embodiments, it will be understood that present description is not intended to limit the present invention(s) to those exemplary embodiments. On the contrary, the present invention(s) is/are intended to cover not only the exemplary embodiments, but also various alternatives, modifications, equivalents and other embodiments, which may be included within the spirit and scope of the present invention as defined by the appended claims.

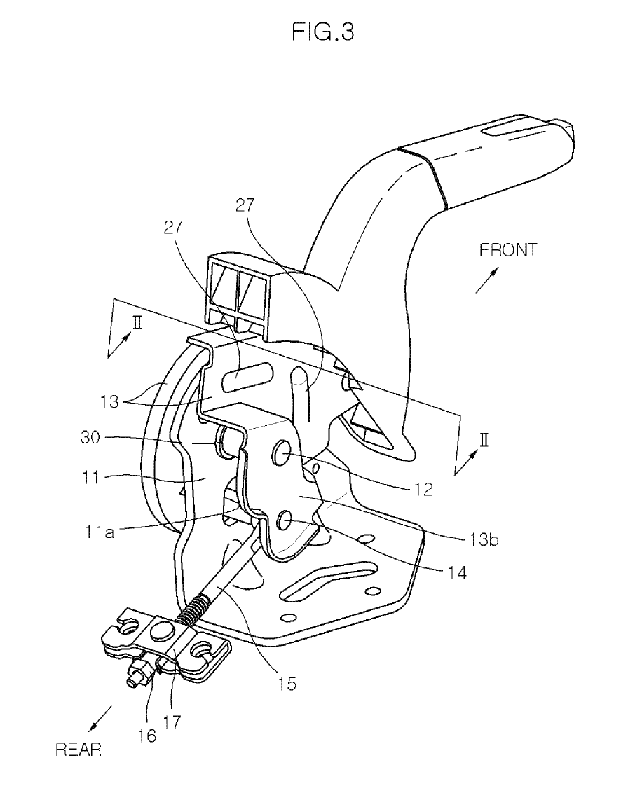

FIG. 3 shows a parking brake system according to an exemplary embodiment of the present invention.

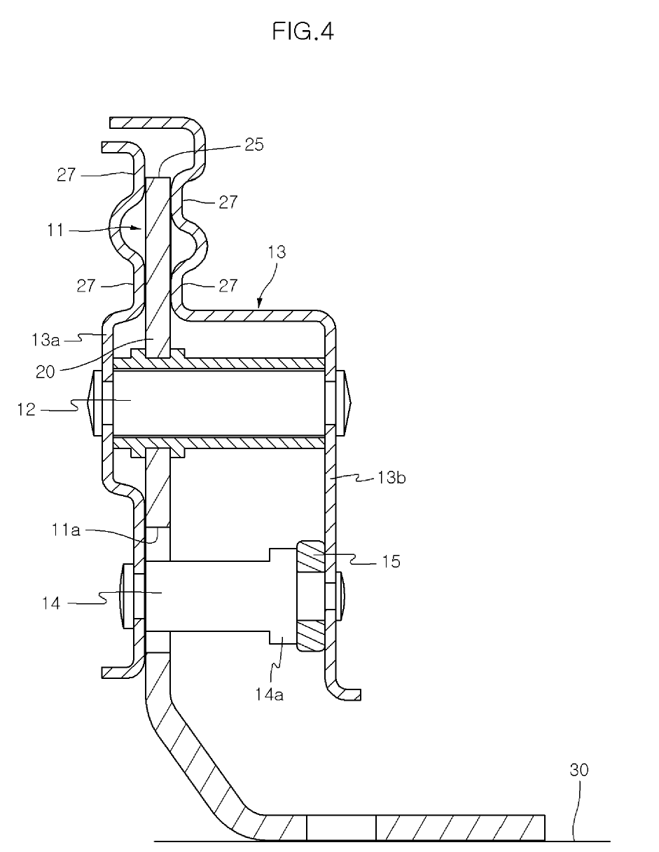

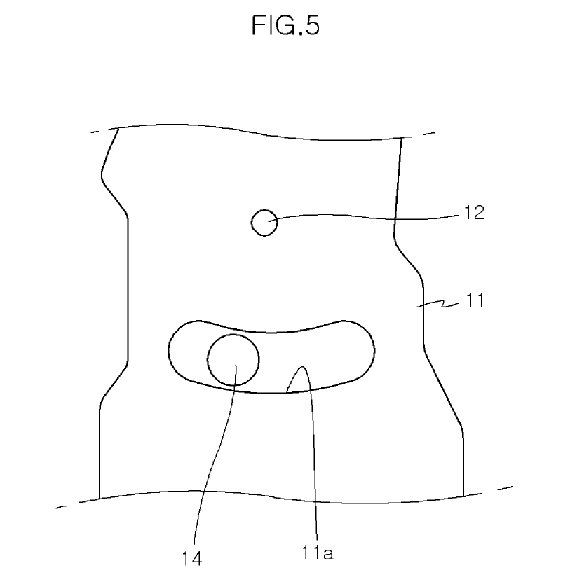

In a parking brake system according to an embodiment of the present invention, as shown in FIGS. 3 to 5, a lever mounting bracket 11 including a vertical portion 20 is fixed to the floor panel 30 at a side of the driver's seat, a vertical fixing portion 13a of an operating lever 13 is rotatably connected to the vertical portion 20 of the lever mounting bracket 11 by a lever hinge 12, and a bending-fixing portion 13b of the operating lever 13 is integrally formed with the vertical fixing portion 13a of operating lever 13, at a predetermined distance from the vertical portion 20 of the lever mounting bracket 11.

Further, a rotary shaft 14 rotating with operating lever 13 is disposed under lever hinge 12, with one end connected to bending-fixing portion 13b.

Further, one end of a cable rod 15 is connected to a portion of rotary shaft 14 at a predetermined distance from the vertical portion 20 of the lever mounting bracket 11 and an equalizer 17 is connected to the other end of cable rod 15 by an adjust nut 16. One end of a cable (not shown) extending to the rear wheels is connected to both ends of equalizer 17.

In this configuration, operating lever 13 has an inverse U-shaped cross section and the vertical portion 20 of the lever mounting bracket 11 is positioned inside the inverse U-shaped cross section.

Therefore, lever hinge 12 passes through the inverse U-shape cross section of operating lever 13 and the vertical portion 20 of the lever mounting bracket 11, and rotary shaft 14 passes through the inverse U-shaped cross section of operating lever 13 and the vertical portion 20 of the lever mounting bracket 11, under the lever hinge 12.

A shaft slot 11a through which rotary shaft 14 passes is formed in the vertical portion 20 of the lever mounting bracket 11 and has an arc slot shape having a predetermined curvature radius from lever hinge 12, the center.

In an exemplary embodiment of the present invention, the lever hinge 12 may include a bracket support spool 30 integrally formed an outer circumference thereof and the vertical portion 20 of the lever mounting bracket 11 is rotatably coupled thereto. In this structure, the lever mounting bracket 11 can support effectively the lever hinge 12 in balance with left and right sides of the parking brake system.

In another exemplary embodiment of the present invention, the vertical fixing portion 13a and the bending fixing portion 13b of the operating lever 13 include a clamping portions 27 respectively at respective upper portion thereof and an upper portion 25 of the vertical portion 20 in the lever mounting bracket 11 is rotatably engaged between the clamping portions 27 of the vertical fixing portion 13b and the bending fixing portion 13b to secure the rotation of the operating lever 13.

Further, a shaft protruder 14a radially extending is integrally formed with a portion of rotary shaft 14 at a predetermined distance from the vertical portion 20 of the lever mounting bracket 11 and one end of cable rod 15 is fitted on the portion of rotary shaft 14 between shaft protruder 14a and operating lever 13.

A parking brake system, which has the vertical portion 20 of lever mounting bracket 11 at the left, operating lever 13 rotatably connected to the vertical portion 20 of lever mounting bracket 11, and cable rod 15 of which one end is connected to a portion of rotary shaft 14 at a predetermined distance to the right from the vertical portion 20 of lever mounting bracket 11, as shown in FIG. 3, is for vehicles with the driver's seat at the left, and a parking brake system with the parts shifted to the left and right in the parking brake system shown in FIG. 3 is for vehicles with the driver's seat at the right.

Therefore, an embodiment of the present invention makes it possible to position equalizer 17 at the center of the console box in the left-right direction of the car body irrespective of the position of the driver's seat, such that it is possible to reduce the left-right width of the console box and correspondingly ensure a wide space for the passengers in the back seat.

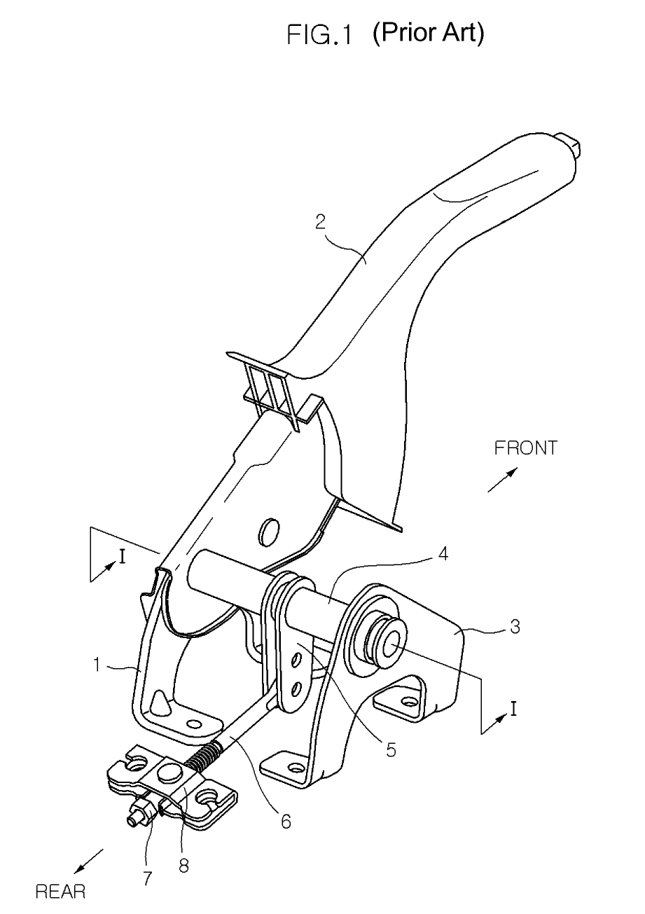

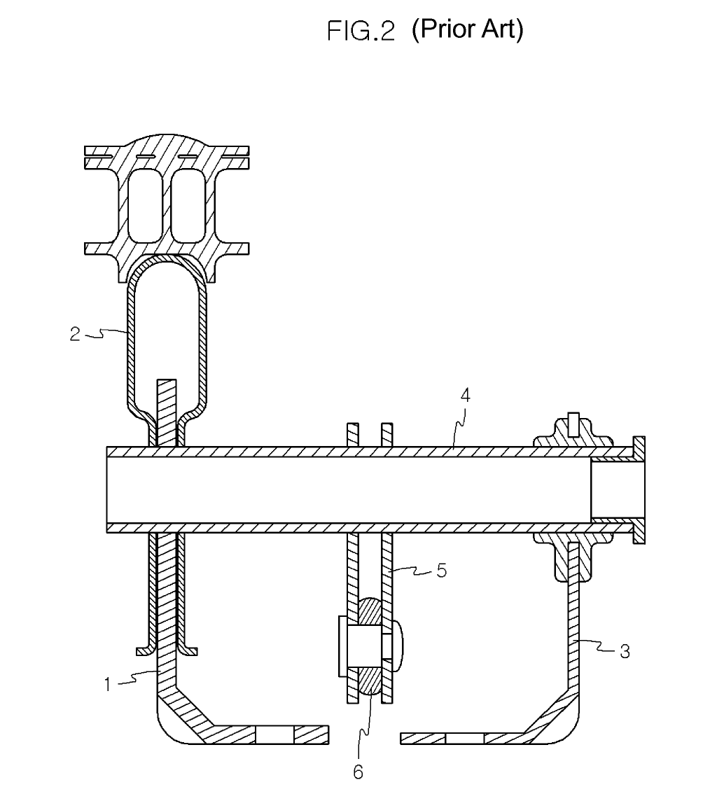

Further, as compared with the parking brake system described with reference to FIGS. 1 and 2, a parking brake system according to an embodiment of the present invention does not require rotary shaft bracket 3 and rotary arm 5, which was used in the related art, such that it is possible to reduce the number of parts and accordingly decreases weight and manufacturing cost.

For convenience in explanation and accurate definition in the appended claims, the terms, “upper”, “lower,” and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A parking brake system comprising:
a lever mounting bracket including a vertical portion and fixed to a floor panel at a side of a driver's seat;
an operating lever including a vertical fixing portion and a bending-fixing portion, wherein the vertical fixing portion is rotatably coupled to the vertical portion of the lever mounting bracket by an end portion of a lever hinge, and the bending-fixing portion is disposed from the vertical portion of the lever mounting bracket with a predetermined distance and rotatably coupled to the vertical portion of the lever mounting by the other end of the lever hinge;
a rotary shaft disposed with a predetermined distance from the lever hinge in a radial direction and having one end connected to the bending-fixing portion to rotate with the operating lever with respect to the lever hinge;
a cable rod having one end connected to a portion of the rotary shaft at a predetermined distance from the vertical portion of the lever mounting bracket; and
an equalizer connected to the other end of the cable rod by an adjust nut.

2. The parking brake system as defined in claim 1, wherein the vertical fixing portion and the bending-fixing portion form an inverse U shape and receives the vertical portion of the lever mounting bracket therein.

3. The parking brake system as defined in claim 1, wherein the other end of the rotary shaft passes through a shaft slot of the lever mounting bracket and is fixed to the vertical fixing portion of the operating lever such that the vertical fixing portion and the bending-fixing portion of the operating lever are rotated with respect to the lever hinge together.

4. The parking brake system as defined in claim 3, wherein the shaft slot has an arc slot shape having a predetermined curvature radius with respect to the lever hinge.

5. The parking brake system as defined in claim 1, wherein a shaft protruder radially extending from the rotary shaft is integrally formed in the portion of the rotary shaft at a predetermined distance from the vertical portion of the lever mounting bracket and the one end of the cable rod is fitted on the portion of the rotary shaft between the shaft protruder and the bending fixing portion of the operating lever.

6. The parking brake system as defined in claim 1, wherein the lever hinge includes a bracket support spool integrally formed onto an outer circumference thereof and the vertical portion of the lever mounting bracket is rotatably coupled thereto.

7. The parking brake system as defined in claim 1, wherein the vertical fixing portion and the bending fixing portion of the operating lever include a clamping portion at respective upper portion thereof respectively and an upper portion of the vertical portion in the lever mounting bracket is rotatably engaged between the clamping portions of the vertical fixing portion and the bending fixing portion.
